(19) United States
(12) Patent Application Publication
(10) Pub. No.: US 2005/0195378 A1
(43) Pub. Date: Sep. 8, 2005

(54) Lithographic apparatus, method of substrate identification, device manufacturing method, substrate, and computer program

(75) Inventors: Michael Van Der Veen, Eindhoven (NL); Christianus Gerardus Maria De Mol, Son en Breugel (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 10/790,252

(22) Filed: Mar. 2, 2004

(51) Int. Cl. G03B 27/42

(52) U.S. Cl. 355/53

(57) ABSTRACT

In a method according to an embodiment of the invention, substrate identification is performed by comparing the measured distance between two features on an unidentified substrate with one or more stored distances. The one or more stored distances are the distances intended during the design of one or more substrates. The unidentified substrate is identified by a stored distance that corresponds to the measured distance.

### BACKGROUND OF THE INVENTION

1. Field of the Invention

The present invention relates to substrate measurement.

2. Description of the Related Art

A lithographic apparatus is a machine that applies a desired pattern onto a target portion of a substrate. Lithographic apparatus can be used, for example, in the manufacture of integrated circuits (ICs). In that circumstance, a patterning structure, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the projection beam in a given direction (the “scanning”-direction) while synchronously scanning the substrate parallel or anti-parallel to this direction.

During production of integrated circuits a substrate is typically fed into a lithographic apparatus several times in order to be able to produce a circuit which consists of several layers on top of each other. As many as 30 layers can be used. The lithographic apparatus used to generate the circuit pattern in the first layer is typically not the same as the lithographic apparatus used to generate the circuit pattern in the final layer. This is because the features of the circuit pattern in the final layer are typically much larger than the features in the first layer, so that a less accurate and therefore less expensive lithographic apparatus can be used to apply the desired circuit pattern into the first layer.

Because of the large quantity of integrated circuits to be produced, several lithographic apparatuses may be involved simultaneously to apply the desired circuit pattern into the first layer or any other layer. Even though the calibrations of the machines are performed as accurately as possible, each apparatus has its own errors. This error may have its effect on the image applied to the substrate or its position. In the event a lithographic apparatus is calibrated between 2 sets of substrates (commonly referred to as lots), the error may also differ for the 2 sets.

When two lithographic apparatuses are used simultaneously, this implies that there may be several patterning structure available containing the pattern to be applied to a given layer. The several patterning structure may also differ due to production tolerances. These differences may lead to differences in the images applied to the substrate or in differences of the positions on the substrates where the images are applied.

Commonly the substrates are marked with a code which is scratched into the substrate. With these codes the substrates can be identified. The relation between the identities of the substrates and the lithographic apparatuses or the patterning structure used to project images onto the substrate is stored. The combination of the stored relations and the identity of the substrates can be used to correct for the differences, based upon knowledge of the previously used lithographic apparatus or patterning structure.

However, if this code is to be read by a lithographic apparatus so that it can identify which substrate it is, or which process steps the substrate has been subjected to, a special sensor is required in the lithographic apparatus. This has effects on the costs of the lithographic apparatus and on the throughput since it must spend time reading the code. Because of the relatively high cost of a lithographic apparatus compared to the other machines used during the total production of integrated circuits, the throughput of the lithographic apparatus is typically the bottleneck in the production process.

On top of that, the space used by a code is not available for integrated circuits. Many steps during the production of an integrated circuit are less expensive per integrated circuit or faster per integrated circuit when more integrated circuits fit on one substrate (without increasing the size of the substrate). Therefore the production costs can be decreased and the throughput can be increased by freeing space on the substrate for extra integrated circuits and refraining from reserving space of codes.

### SUMMARY OF THE INVENTION

A lithographic apparatus according to one embodiment of the invention includes at least one sensor arranged to measure positions of first and second features on a substrate, and an identification unit arranged to compare a measured relative position of the first and second features based on the measured positions with at least one of a plurality of stored relative positions of first and second features. Each of the plurality of stored relative positions of first and second features is associated with information characterising at least one substrate. The identification unit is also arranged to indicate a correspondence between the measured relative position of the first and second features and one of the plurality of stored relative positions of first and second features.

A method according to another embodiment of the invention includes measuring positions of first and second features on a substrate. The method also includes comparing a measured relative position between the first and second features on the substrate, based on the measured positions, with at least one of a plurality of stored relative positions of first and second features. Each of the plurality of stored relative positions of first and second features is associated with information characterizing at least one substrate. The method also includes indicating a correspondence between the measured relative position of the first and second features on the substrate and one of the plurality of stored relative positions of first and second features.

A method of labelling a substrate according to another embodiment of the invention includes providing the substrate with a first feature; providing the substrate with a second feature; and recording a correspondence between a relative position of the first and second features and information characterizing the substrate. The information may distinguish the substrate from others in a group and/or indicate membership of the substrate in a group.

A method of labelling a substrate according to another embodiment of the invention includes providing the substrate with a first feature, and providing the substrate with a second feature at a position relative to the first feature so that the relative positions of the first and second features provide characterising information regarding the substrate.

A lithographic apparatus according to another embodiment of the invention includes one or more sensors arranged to measure the relative positions of first and second features on a substrate, and an identification unit arranged to compare the measured relative positions of the first and second features on the substrate with one or more stored relative positions of the first and second features. The one or more stored relative positions of the first and second features are each associated with information characterising one or more substrates. The identification unit is arranged to determine if the measured relative positions of the first and second features on the substrate corresponds with one of the one or more stored relative positions of the first and second features.

A device manufacturing method according to another embodiment of the invention includes manufacturing a number of the devices on a set of substrates. Each substrate is provided with a marker which determines the position of the substrate, and each substrate is provided with a feature on a position relative to the marker such that the relative position is indicative of a setting of a process step of the substrate.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a patterning structure containing a first circuit pattern, a reference mark and an alignment mark, which may be used to implement an embodiment of the invention.

FIG. 3 shows a substrate having a substrate alignment mark, a first circuit pattern and a substrate reference mark on substrate W1 according to an embodiment of the invention.

FIG. 4 shows a substrate having a substrate alignment mark, a first circuit pattern and a substrate reference mark on substrate W2 according to an embodiment of the invention.

FIG. 5 shows an unidentified substrate having a substrate alignment mark, a first circuit pattern and a substrate reference mark on substrate W2 according to an embodiment of the invention.

FIG. 6 shows the positions of a substrate alignment mark and a substrate reference mark as defined, as realised in practice and as measured.

### DETAILED DESCRIPTION OF THE INVENTION

Embodiments of the present invention include methods and apparatus configured to provide substrate identification which solve one or more problems as described above.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCD's), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning structure” used herein should be broadly interpreted as referring to structure that can be used to impart a projection beam with a pattern in its cross-section such as to create a pattern in a target portion of the substrate. It should be noted that the pattern imparted to the projection beam may not exactly correspond to the desired pattern in the target portion of the substrate. Generally, the pattern imparted to the projection beam will correspond to a particular functional layer in a device being created in the target portion, such as an integrated circuit.

Patterning structure may be transmissive or reflective. Examples of patterning structure include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The support structure supports, i.e. bares the weight of, the patterning structure. It holds the patterning structure in a way depending on the orientation of the patterning structure, the design of the lithographic apparatus, and other conditions, such as for example whether or not the patterning structure is held in a vacuum environment. The support can be using mechanical clamping, vacuum, or other clamping techniques, for example electrostatic clamping under vacuum conditions. The support structure may be a frame or a table, for example, which may be fixed or movable as required and which may ensure that the patterning structure is at a desired position, for example with respect to the projection system. Any use of the terms “reticle” or “mask” herein may be considered synonymous with the more general term “patterning structure”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “lens” herein may be considered as synonymous with the more general term “projection system”.

The illumination system may also encompass various types of optical components, including refractive, reflective, and catadioptric optical components for directing, shaping, or controlling the projection beam of radiation, and such components may also be referred to below, collectively or singularly, as a “lens”.

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art e.g. for effectively increasing the numerical aperture of projection systems.

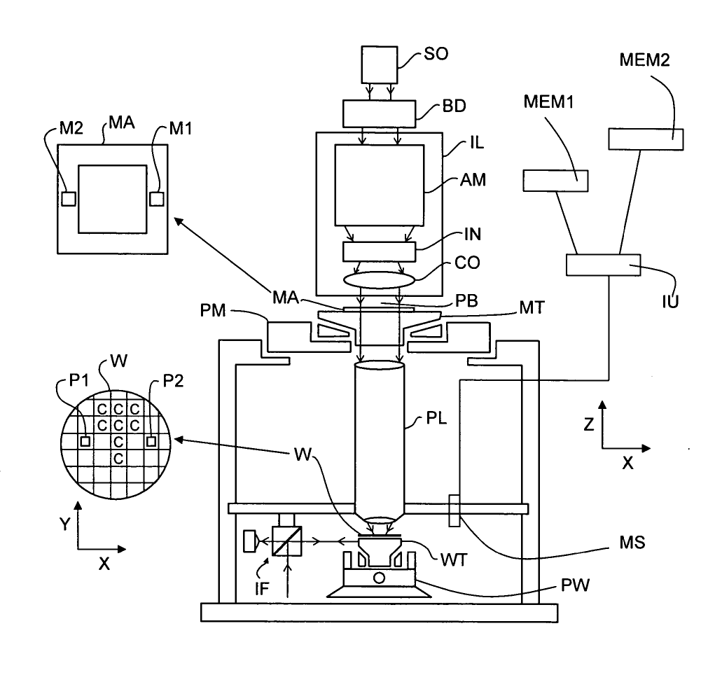

FIG. 1 schematically depicts a lithographic apparatus according to a particular embodiment of the invention. The apparatus comprises:

an illumination system (illuminator) IL for providing a projection beam PB of radiation (e.g. UV radiation or EUV radiation).

a first support structure (e.g. a mask table) MT for supporting patterning structure (e.g. a mask) MA and connected to first positioning structure PM for accurately positioning the patterning structure with respect to item PL;

a substrate table (e.g. a wafer table) WT for holding a substrate (e.g. a resist-coated wafer) W and connected to second positioning structure PW for accurately positioning the substrate with respect to item PL; and

a projection system (e.g. a refractive projection lens) PL for imaging a pattern imparted to the projection beam PB by patterning structure MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be an integral part of the apparatus, for example when the source is a mercury lamp. The source SO and the illuminator IL, together with the beam delivery system BD if required, may be referred to as a radiation system.

The illuminator IL may comprise adjusting structure AM for adjusting the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation, referred to as the projection beam PB, having a desired uniformity and intensity distribution in its cross-section.

The projection beam PB is incident on the mask MA, which is held on the mask table MT. Having traversed the mask MA, the projection beam PB passes through the lens PL, which focuses the beam onto a target portion C of the substrate W. With the aid of the second positioning structure PW and position sensor IF (e.g. an interferometric device), the substrate table WT can be moved accurately, e.g. so as to position different target portions C in the path of the beam PB. Similarly, the first positioning structure PM and another position sensor (which is not explicitly depicted in FIG. 1) can be used to accurately position the mask MA with respect to the path of the beam PB, e.g. after mechanical retrieval from a mask library, or during a scan. In general, movement of the object tables MT and WT will be realised with the aid of a long-stroke module (coarse positioning) and a short-stroke module (fine positioning), which form part of the positioning structure PM and PW. However, in the case of a stepper (as opposed to a scanner) the mask table MT may be connected to a short stroke actuator only, or may be fixed. Mask MA and substrate W may be aligned using mask alignment marks M1, M2 and substrate alignment marks P1, P2.

The depicted apparatus can be used in the following preferred modes:

1. In step mode, the mask table MT and the substrate table WT are kept essentially stationary, while an entire pattern imparted to the projection beam is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the projection beam is projected onto a target portion C (i.e. a single dynamic exposure). The velocity and direction of the substrate table WT relative to the mask table MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning structure, and the substrate table WT is moved or scanned while a pattern imparted to the projection beam is projected onto a target portion C. In this mode, generally a pulsed radiation source is employed and the programmable patterning structure is updated as required after each movement of the substrate table WT or in between successive radiation pulses during a scan. This mode of operation can be readily applied to maskless lithography that utilises programmable patterning structure, such as a programmable mirror array of a type as referred to above.

Combinations and/or variations on the above described modes of use or entirely different modes of use may also be employed.

The lithographic apparatus is represented in FIG. 1 with a rectangular co-ordinate system. In the co-ordinate system z is defined as being parallel to the optical axis of the projection system PL. The x and y co-ordinates are perpendicular to the optical axis of the projection system. In this document for a finite area (for example a target portion C), the side of the area with the lowest x co-ordinate is taken as the x co-ordinate of that area, although any other convention may be used, and different conventions may be used for different areas if desired.

Alignment may be performed by measuring the position of substrate alignment marks P1,P2 with an off-axis mark sensor MS. If the measurement by the sensor is performed off-axis the mark does not have to be near the optical axis of the projection system PL. If the measurement is performed off-axis, it may be desirable or necessary to know or determine the relation between the position of the off-axis measurement and the optical axis of the projection system PL. Position sensor IF (e.g. a system including at least one interferometer or other optical or capacitive sensor) can be used to relate the position of the off-axis measurement and the optical axis of the projection system PL.

Mark sensor MS is connected to an identification unit IU, which is also connected to a first memory MEM1 and a second memory MEM2. The purpose of the first memory MEM1 is to store the defined positions of different areas on the substrates. Defined positions in this document mean the positions as engineered, i.e. as intended during design of a lithographic step. In practise the positions can deviate from the defined positions. Likewise, in this document defined relative positions are the engineered relative positions. In practise the relative positions can deviate from the defined relative positions, i.e. the intended relative positions. The purpose of the second memory MEM2 is to store the relative positions of the different areas on the substrates.

The substrate alignment marks P1, P2 are areas formed on the substrate with a fixed position. These substrate alignment marks P1,P2 provide reference positions for further process operations. By using the same reference positions in a first patterning operation as in a second patterning operation, the patterns in both operations can be positioned directly on top of each other.

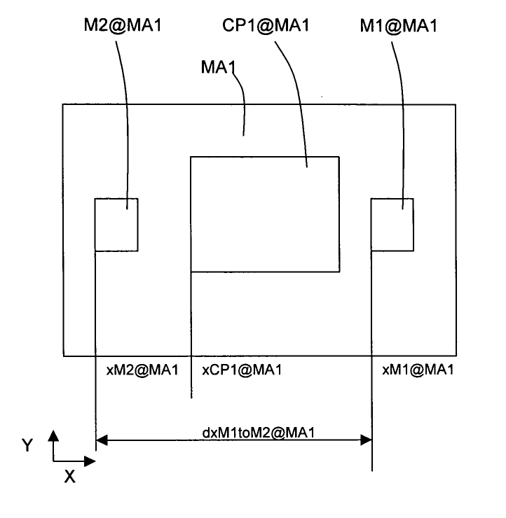

In an embodiment of the invention, the patterning structure MA contains an alignment mark pattern M1@MA1, a first circuit pattern CP1@MA1 and a reference mark pattern M2@MA1, each covering a separate area (see FIG. 2). The term ‘first circuit pattern’ is intended to mean the circuit pattern of the first layer of the substrate.

In this document the names of the areas will contain an indication of the patterning structure or substrate on which they are formed. The names of the areas on patterning structure MA1 contain @MA1, the names of the areas on patterning structure MA2 contain @MA2. The names of the areas on substrate W1 contain @W1 and the names of the areas on substrate W2 contain @W2. The x co-ordinate of an alignment mark pattern M1@MA1 is xM1@MA1, the x co-ordinate of first circuit pattern CP1@MA1 is xCP1@MA1 and the x co-ordinate of reference mark pattern M2@MA1 is xM2@MA1.

The relative x co-ordinates of all three areas M1@MA1,CP1@MA1,M2@MA1 are known. The names of the relative positions contain the same indication of the patterning structure or substrate on which they are formed (for instance @MA1). Furthermore the names are built up as dxAtoB@C wherein x indicates a direction in the co-ordinate system, A and B indicate which areas are involved and C indicates on which patterning structure or substrate they are formed. Here the indication of the patterning structure or substrate is left out of the name of the areas A and B.

As an example, the relative x co-ordinate between alignment mark pattern M1@MA1 and reference mark pattern M2@MA1 is dxM1toM2@MA1.

In use, the lithographic apparatus may illuminate alignment mark pattern M1@MA1, first circuit pattern CP1@MA1 and/or reference mark pattern M2@MA1 separately, so that the images are projected onto the substrate separately. This allows the position of each pattern as projected onto the substrate to be selected independently.

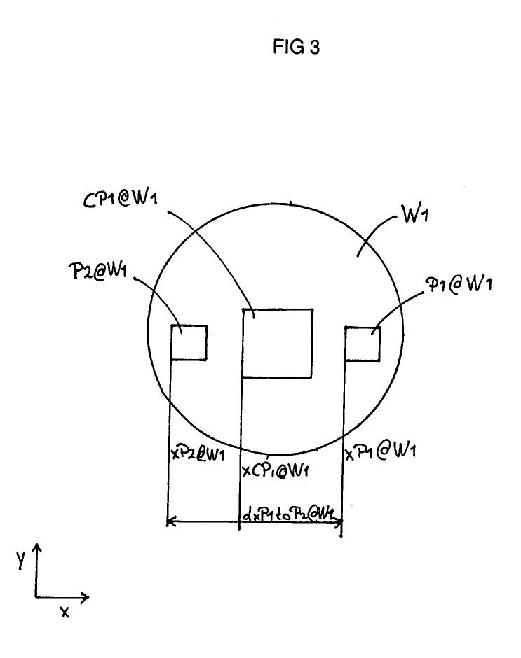

Images of all three areas are projected onto a substrate W1 (FIG. 3) by illuminating the patterning structure MA1. In practice, first circuit pattern CP1@MA1 is projected onto substrate W1 repeatedly so that each target portion C is illuminated once. FIG. 3 only shows one target portion C for simplicity reasons. The images are projected onto defined positions of substrate W1 being xP1@W1, xCP1@W1 and xP2@W1 respectively (FIG. 3) which are stored in the first memory unit MEM1 (FIG. 1). During the projection of the images onto substrate W1, there is a radiation-sensitive material on top of the substrate W1. The radiation-sensitive material changes locally due to the energy in the projected images.

After illumination the substrate W1 will be processed. During processing local differences in the radiation-sensitive material per x co-ordinate are converted to presence or absence of semiconducting material at the same x co-ordinate. Some or all of the processing procedure may be performed outside the lithographic projection apparatus. Following processing, substrate W1 contains a substrate alignment mark P1@W1, a first circuit pattern CP1@W1 on substrate W1 and a substrate reference mark P2@W1.

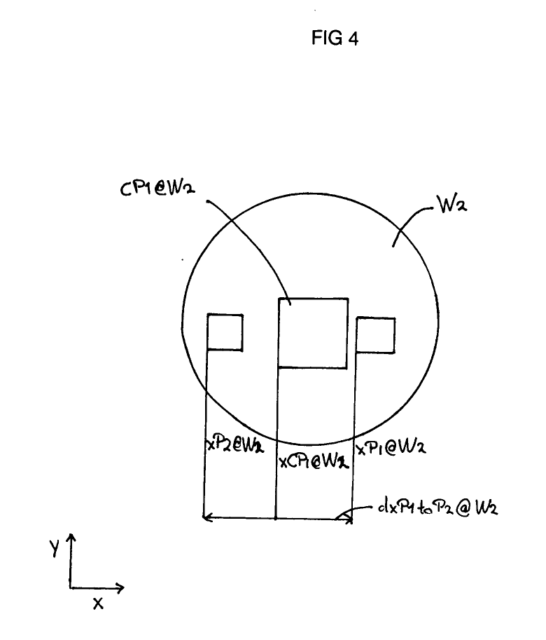

The images of alignment mark P1@MA1, first circuit pattern CP1@MA1 and reference mark P2@MA1 are projected on a second substrate W2 using the same lithographic apparatus. For the second substrate W2 the defined x co-ordinate of the substrate alignment mark is xP1@W2 (FIG. 4), which is also stored in memory unit MEM1. This value differs from xP1@W1. The defined x co-ordinate xCP@W2 for the first circuit pattern on substrate W2 is equal to that on substrate W1. The defined x co-ordinate xP2@W2 of reference mark P2@W2 is also equal to that on substrate W1.

Substrate W2 is also processed. The substrate W2 now contains a substrate alignment mark P1@W2, a first circuit pattern CP1@W2 on substrate W2 and a substrate reference mark P2@W2.

For substrate W1 the distance dxP1toP2@W1 along the x-axis between the position of the substrate reference mark P2@W and the substrate alignment mark P1@W1 is calculated by the identification unit IU (FIG. 1) using
dxP1toP2@W1=xP1@W1−xP2@W1
and stored as a first memory entry in the second memory unit MEM2 (FIG. 1) which identifies substrate W1.

For substrate W2 the distance dxP1toP2@W2 along the x-axis between the position of the substrate reference mark P2@W and the substrate alignment mark P1@W2 is calculated by the identification unit IU using
dxP1toP2@W2=xP1@W2−xP2@W2
and stored in a second memory entry in the second memory unit MEM2, which identifies substrate W2.

The clear difference between the distances dxP1toP2@W1 and dxP1toP2@W2 enables identification of substrate W1 and substrate W2.

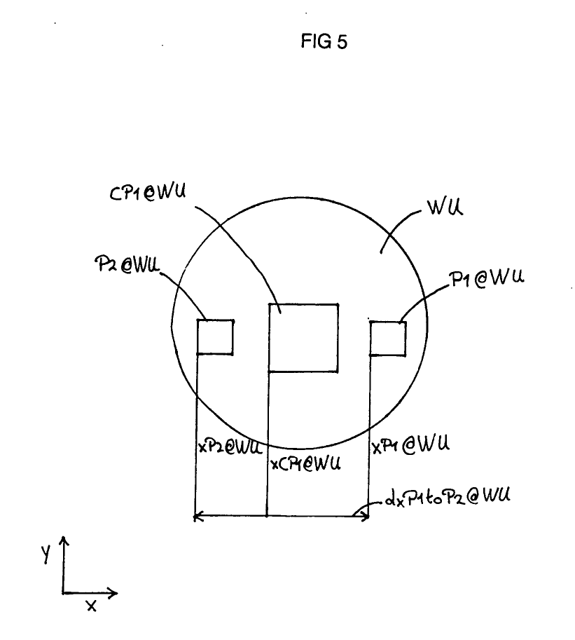

An unidentified substrate WU (FIG. 5) is brought into the lithographic projection apparatus to form a second circuit pattern CP2@WU on top of the first circuit pattern CP1@WU on substrate WU. In order to form the second circuit pattern CP2@WU exactly on top of the first circuit pattern CP1@WU, the position of the first circuit pattern CP1@WU on substrate WU must be determined. The substrate WU on substrate table WT is positioned in the measuring field of mark sensor MS (FIG. 1). Mark sensor MS measures the position xP1@WU of substrate alignment mark P1@WU and position xP2@WU of substrate reference P2@WU.

The identification unit IU calculates the distance dxP1toP2@WU along the x-axis of the measured position xP1@WU of substrate alignment mark P1@WU and position xP2@WU of substrate alignment mark P2@WU.

The distance dxP1toP2@WU of the measured positions is compared to the entries in the second memory MEM2 by identification unit IU. The distance dxP1toP2@WU of the measured positions is equal to the first memory entry in second memory unit MEM2 containing dxP1toP2@W1. Therefore, the identification unit IU will identify the unidentified substrate as substrate W1.

If substrate W2 would have been fed into the lithographic apparatus instead of substrate W1, dxP1toP2@WU would have been the distance of the measured positions of substrate alignment marker P1@W2 and P2@W2. This distance dxP1toP2@WU would have been equal to the second memory entry of second memory unit MEM2 and the identification unit IU would have identified the unidentified substrate as substrate W2.

At least some embodiments of the invention can be used to correct for differences to the engineered status of the substrates. For example the first circuit pattern CP1@W1 on substrate W1 is formed by projecting the image of the first circuit pattern CP1@MA1 on patterning structure MA1 onto substrate W1 via a first lithographic apparatus LA1. The first circuit pattern CP1@W2 on substrate W2 is formed by projecting the image of the first circuit pattern CP1@MA1 on patterning structure MA1 onto substrate W2 via a second lithographic apparatus LA2. Due to an error in second lithographic apparatus LA2, the relative position of the first circuit pattern CP1@W2 on substrate W2 and substrate reference mark P2@W is not as defined. The error in second lithographic apparatus LA2 is known from a previous measurement and this information is shared with the first lithographic apparatus LA1.

It may be desired to image the second circuit pattern CP2@MA2 via the first lithographic apparatus LA1 onto a substrate WU without error correction. The identity of the substrate WU is initially unknown to the first lithographic apparatus LA1. The identity of the substrate WU is determined as explained earlier. Based upon the identity of the substrate, the lithographic apparatus determines which correction must be done when imaging the second circuit pattern CP2@MA2 onto the substrate. If the substrate WU is identified as substrate W1, no correction is required. If the substrate WU is identified as substrate W2, a correction may be required. Second circuit pattern CP2@MA2 is imaged onto substrate W2 correcting for the error in lithographic apparatus LA2.

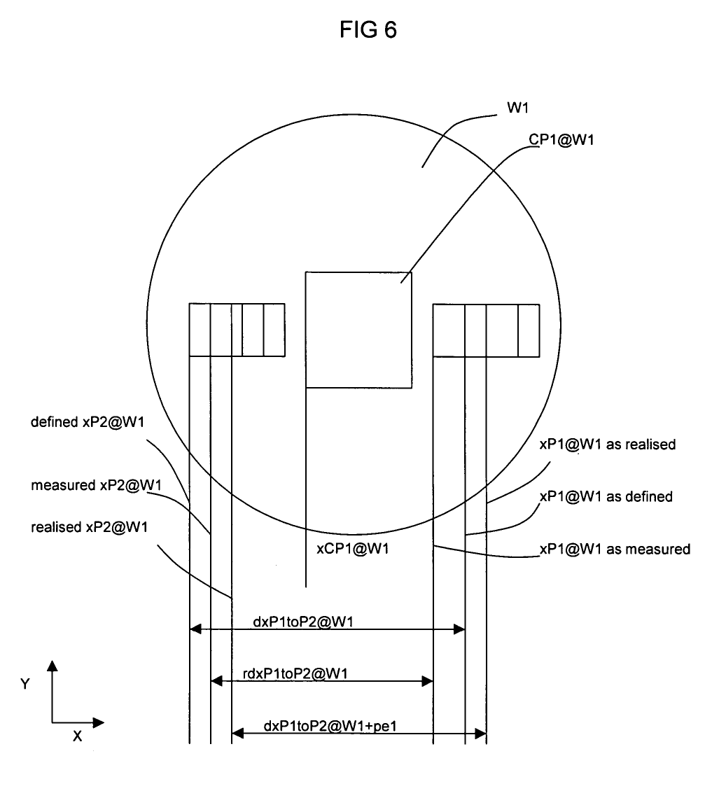

At least some embodiments of the invention can be provided with a device or other structure to take into account the position and/or measurement errors associated with substrate alignment mark P1 and substrate reference mark P2. The defined position of the x co-ordinate xP2@W of the substrate reference mark is equal for both substrates W1,W2. The defined position of the x co-ordinate xP1@W1 of the substrate alignment mark on substrate W1 differs from the defined position of the x co-ordinate xP1@W2 of the substrate alignment mark on substrate W2. Apart from these defined differences, in practice errors will also occur. The relative distance dxP1toP2@W1 from substrate alignment mark P1 to substrate reference mark P2 on substrate W1 as measured can be expressed as
rdxP1toP2@W1=dxP1toP2@W1+pe1+me1,
where pe1 is a position error and me1 is a measurement error (see FIG. 6). An example of a position error is the error made in the distance between the circuit pattern CP1@MA1 on patterning structure MA1 and of the reference mark P2@MA1 during production of the patterning structure MA1. As explained the lithographic apparatus may image the circuit pattern CP1@MA1, reference mark P2@MA1 and/or alignment mark P1@M1 separately. Where in practice the image of the circuit pattern CP1@MA1 is applied to each target portion C (FIG. 1) on substrate W1 only 1 image of reference mark P2@MA1 and 1 image of alignment mark P1@MA1 is applied to substrate W1. The imaging is done using information on the relative positions on patterning structure MA1 and the defined positions on substrate W1.

In the event the relative distance between reference mark P2@MA1 and circuit pattern CP1@MA1 on the patterning structure MA1 is not measured and accounted for during the steps of imaging the reference mark P2@MA1 and the circuit pattern CP1@MA1 onto substrate W1, the relative distance rdxCP1toP2@W1 may not be equal to dxCP1toP2@W.

Examples of measurement errors are errors made by the mark sensor and errors by the position sensor IF (FIG. 1).

For substrate W2 the corresponding distance when measured can be expressed as
rdxP1toP2@W2=dxP1toP2@W2+pe2+me2.

Both measured relative distances rdxP1toP2@W1 and rdxP1toP2@W2 may contain error terms. Identification unit IU compares the measured distance wD to the defined distances dxP1toP2@W1 and dxP1toP2@W2 between substrate alignment mark P1 and substrate reference mark on substrate W1 and substrate W2. It is possible that none of the defined distances dxP1toP2@W1 and dxP1toP2@W2 will be equal to the measured distance wD. Identification unit IU will determine the difference between the measured distance wD and each of the defined distances. The defined distance with the smallest difference to the measured distance wD may be selected as identifying the substrate. In the event |wD-dxP1toP2@W1|<|wD-dxP1toP2@W2| the identification unit IU will identify the substrate as substrate W1. In the event that
|wD-dxP1toP2@W1|>|wD-dxP1toP2@W2|
the identification unit IU will identify the substrate as substrate W2.

On the second substrate W2 the defined position of the x co-ordinate xCP1@W for the first circuit pattern is equal to that on substrate 1. On the second substrate W2 the defined position of the x co-ordinate xP2@W is also equal to that on substrate 1 also. On both substrates W1,W2 the position of the first circuit pattern CP1@W1, CP1@W2 can be determined by measuring the x co-ordinate xP2@W1, xP2@W2 of the substrate reference mark and accounting for the defined relative positions of the first circuit pattern CP1@W1, CP1@W2 and the substrate reference mark P2@W1, P2@W2. This distance will be referred to as dCP1toP2@W. The relation is
xCP1@W=xP2@W+dCP1toP2@W. (1)

Identification unit IU is arranged to be able to read the positions xCP1@W and xP2@W from memory unit MEM1 and to compute this distance dCP1toP2@W.

On the processed substrate W1 the distance will be referred to as rdCP1toP2@W1. The relation with the defined distance dCP1toP2@W is
rdCP1toP2@W1=dCP1toP2@W+ε1. (2)

The term ε1 is a position error similar to position error pe1.

The defined distance between first substrate pattern CP1@W1 and substrate alignment mark P1@W1 is referred to as dCP1toP1@W1. The distance as realised on substrate W1 will be referred to as rdCP1toP1@W1 and can be expressed as
rdCP1toP1@W1=dCP1toP1@W1+δ1, (3)
wherein δ is a position error similar to position error ε1.

Likewise the on substrate W2, defined distance between first circuit pattern CP1@W2 on substrate W2 and substrate alignment mark P1@W2 will be dCP1toP1@W2 and the realised distance will be rdCP1toP1@W2. The relation can be expressed as
rdCP1toP1@W2=dCP1toP1@W2+δ2, (4)
wherein δ2 is a position error similar to position errors ε1 and δ1.

The measured x co-ordinate xP2@W1 of substrate reference mark P2@W1 can be expected to be at
xP2@W1=xP2@W+ξ1. (5)

The term ξ1 is a measurement error similar to measurement error me1.

The measured x co-ordinate xP1@W1 of substrate alignment mark P1@W1 can be expected at
xP1@W1=xP1@W1+ζ1. (6)

The term ζ1 here also is measurement errors. This error does not need to be equal to the measurement error ξ1, for instance because of noise.

Once both the substrate reference mark P2@W and the substrate alignment mark are formed on the substrate and the substrate W1 is developed, both their positions can be read and can be used to determine the position of the first circuit pattern CP1@W1 on substrate W1.

The position of the first circuit pattern on substrate W1 can be estimated from
xCP1@W1=xP2@W1+dCP1toP2@W. (7)
Note that here the defined distance between CP1toP2@W is used instead of the realised distance, since the realised position of first circuit pattern xCP1@W1 can not be measured.

The position of first circuit pattern on substrate W2 can be derived from
xCP1@W2=xP2@W2+dCP1toP2@W. (8)

The position of the first circuit pattern CP1@W1 on substrate W1 can also be estimated from a measured position of substrate alignment mark P1@W1. This can be done via
xCP1@W1=xP1@W1+dCP1toP1@W (9)

For substrate W2 the position of the first circuit pattern CP1@W2 can be estimated via
xCP1@W2=xP1@W2+dCP1toP1@W. (10)

After identification of the substrate, it is known if the substrate contains substrate alignment mark P1@W1 or P1@W2, i.e. if the substrate is substrate W1 or substrate W2. In the event the substrate is substrate W1, the position of the first circuit pattern can be estimated using either the measured position of the substrate reference mark (formula 7) or the measured position of the substrate alignment mark (formula 9). The estimation can also use the measured position of both the substrate reference mark and the measured position of the substrate alignment mark in order to reduce the error terms. The effect of adding the two estimations of formula 7 and 9 and dividing the result by 2 is
xCP1@W1=(xP2@W1+dCP1toP2@W+xP1@W1+dCP1toP1@W)/2. (11)

Filling in formula 5,2,6 and 3 clarifies how the errors translate into the estimated xCP1@W1
xCP1@W1=(xP2@W+ξ1+rdCP1toP2@W1−ε1+xP1@W+ζ1−rdCP1toP1+δ1)/2. (12)

In the event that more substrate alignment marks are used, the above expression can be changed accordingly to minimise the estimation error. Using more substrate alignment marks of course also opens the possibility to uniquely identify a larger set of substrates.

The position of the substrate alignment mark P1 is drawn in FIG. 1 to be in an area similar to the target areas C. Because of the curvature of the substrate, on the edge of the substrate there are areas which are too small to fit a complete circuit. These areas are called mouse-bites. Mouse-bites can advantageously be used to contain substrate reference marks or substrate alignment marks, thereby freeing target areas C for patterning circuits.

The lines between the target areas C are commonly referred to in lithography as scribelanes. The circuits are separated from each other along these scribelanes. The scribelanes can advantageously be used to contain substrate reference marks or substrate alignment marks, thereby freeing target areas C for patterning circuits.

In the embodiments above, the substrate alignment marks and substrate reference marks are only read after processing of the substrate, prior to imaging a subsequent layer. In specific circumstances it is possible to read the markers without further processing (e.g. subsequent to exposure, or subsequent to development of an exposed resist layer). In this case, the markers are said to be latent. It will be clear to a person skilled in the art, that latent markers can be used in embodiments of the invention.

It will be clear to a person skilled in the art, that any feature on the substrate or of the substrate of which the position can be determined, could replace the substrate reference mark. It will be clear to a person skilled in the art, that the relative positions of the substrate reference marks and the substrate alignment marks may indicate or contain information characterising the substrate such as a date, a serial number processing information or factory information. It may also be the number of substrates within a series with the same characteristics. Together with the serial number, for instance 7, the number of substrates within a series of for instance 9 substrates would indicate that it concerns substrate number 7 of 9 substrates. In all these cases this characterising information regarding the substrate may be encoded in the relative positions. The characterising information regarding the substrate can be decoded only with a known relation between the relative positions and the characterising information corresponding to certain relative positions. It will be understood that the characterising information regarding the substrate such as date, serial number, processing information or factory information can be considered to identify a substrate or set of substrates.

It will be clear to a person skilled in the art, that the characterising information may be used to calibrate the lithographic apparatus. For instance the identity of a calibration substrate may be associated with height information such as the difference in height between two positions on the substrate (x1,y1,z1),(x2,y2,z2) (not shown). Differences in height are distances along the z-axis (FIG. 1). The measured distance is compared with a previously measured distance according to the characterising information. The ratio between the previously measured distance and the measured distance can be used as a calibration ratio. Multiplying measured z-co-ordinates on the calibration substrate with the calibration ratio will result in calibrated z-co-ordinates. In other words, the lithographic apparatus is calibrated.

The calibration ratio may also be used to calibrate measurements on other substrates W. The z-co-ordinates measured on other substrate W are multiplied with the calibration ratio to give a calibrated z-co-ordinate.

It will be clear to a person skilled in the art, that within each layer on the substrate new characterising information regarding the substrate can be imaged. This can be realised by imaging a new set of an alignment marker and a reference marker onto the substrate. The new set of markers can for instance be imaged into the scribelanes of the substrate.

In the embodiments of the invention described above an off-axis mark sensor MS (FIG. 1) is used. The mark sensor MS could equally well have been on-axis. If the measurement by the sensor is performed by holding the mark so that it crosses the optical axis of the projection system PL, the sensor is called an on-axis sensor.

Specifically in a system with two substrate tables (not shown), the measurement with the mark sensor MS of substrate W2 can be performed simultaneously with illumination of substrate W1 using the projection system PL. This way the identification can be completed before the substrate is brought underneath the projection system PL.

In the embodiments above, the patterning structure MA1 contains an alignment mark M1 and a reference mark M2. Because the marks are imaged separately onto substrate W1, it will be clear to a person skilled in the art that only alignment mark M1@MA1 is required on patterning structure MA1. The provision is that the alignment mark M1@MA1 on patterning structure MA1 is imaged onto substrate W1 at the position of substrate alignment mark P1@W1 and at the position of substrate reference mark P2@W1. Here the relative positions of substrate alignment mark P1@W1 and P2@W1 can be defined to characterise information regarding substrate W1.

An identification unit as described herein may include one or more arrays of logic elements, such as microcontrollers, microprocessors, or other processing units. Such an array may be configured to execute software and/or firmware instructions. Alternatively, such an array may at least in part be hard-wired (e.g. an application-specific integrated circuit). As a further alternative, such an array may be fixed but reprogrammable (e.g. a field-programmable gate array).

While specific embodiments of the invention have been described above, it will be appreciated that the invention may be practised otherwise than as described. The description is not intended to limit the invention. For example, embodiments of the invention also include computer programs including one or more sets (e.g. sequences) of machine- executable instructions describing one or more methods as disclosed herein, and data storage media (e.g. semiconductor memory (volatile and/or non-volatile), magnetic and/or optical disk media, etc.) containing such instructions.

1. A lithographic apparatus comprising:
at least one sensor arranged to measure positions of first and second features on a substrate;
an identification unit arranged to compare a relative position of the first and second features, said relative position being based on the measured positions, with at least one of a plurality of stored relative positions of first and second features, each of the plurality of stored relative positions of first and second features being associated with information characterising at least one substrate,
wherein the identification unit is arranged to indicate a correspondence between the relative position of the first and second features and one of the plurality of stored relative positions of first and second features.

2. The lithographic apparatus according to claim 1, wherein the information characterising at least one substrate indicates at least one of: a substrate identity, height information of a calibration substrate, a quantity of substrates in a set of substrates to which the substrate belongs, a date of an earlier process operation undergone by the substrate, a time of an earlier process operation undergone by the substrate, an apparatus used in an earlier operation of the lithographic process, and a patterning structure used in an earlier operation of the lithographic process.

3. The lithographic apparatus according to claim 2, wherein the identification unit is arranged to indicate a correspondence between the relative position of the first and second features and a stored relative position of first and second features which is closest to the relative position.

4. The lithographic apparatus of claim 1, wherein the relative position of the first and second features includes a first distance in a first direction and a second distance in a second direction different from the first direction, and
wherein the identification unit is arranged to compare the first distance with at least one stored distance in the first direction, the at least one stored distance in the first direction being indicative of information about a corresponding substrate, and
wherein the identification unit is arranged to compare the second distance with at least one stored distance in the second direction, the at least one stored distance in the second direction being indicative of information about the corresponding substrate.

5. The lithographic apparatus of claim 1, wherein the apparatus includes a positioning structure arranged to position the substrate based on a position of the first feature as measured by the at least one sensor.

6. The lithographic apparatus of claim 1, wherein the apparatus includes a positioning structure configured to determine a position of the substrate based on the one of the plurality of stored relative positions of first and second features.

7. The lithographic apparatus of claim 1, wherein the apparatus includes a calibration structure configured to calibrate the apparatus based on the information characterising at least one substrate associated with the one of the plurality of stored relative positions of the first and second features.

8. The lithographic apparatus of claim 1, wherein the identification unit includes an array of logic elements and a memory storing instructions executable by the array of logic elements.

9. A method of obtaining information regarding a substrate, said method comprising:
measuring positions of first and second features on a substrate;
comparing a relative position between the first and second features on the substrate, said relative position being based on the measured positions, with at least one of a plurality of stored relative positions of first and second features, each of the plurality of stored relative positions of first and second features being associated with information characterizing at least one substrate; and
indicating a correspondence between the relative position of the first and second features and one of the plurality of stored relative positions of first and second features.

10. The method according to claim 9, wherein said indicating a correspondence includes indicating a correspondence between the relative position of the first and second features and a stored relative position of first and second features which is closest to the relative position.

11. A device manufacturing method comprising:
manufacturing a plurality of devices on a set of substrates, each substrate having a marker and a feature at a unique position relative to the marker;
for at least one of the set of substrates, measuring a position of at least one of the feature and the marker relative to the other of the feature and the marker;
comparing the measured relative position to at least one of a plurality of entries in a data set, each entry corresponding to a relative position between the marker and feature of one of the set of substrates; and
identifying the substrate by selecting an entry corresponding to the measured relative position,
wherein said manufacturing includes modifying a process operation based on the identity of the substrate.

12. A method of labelling a substrate, said method comprising:
providing the substrate with a first feature;
providing the substrate with a second feature; and
recording a correspondence between a relative position of the first and second features and information characterizing the substrate.

13. The method according to claim 12, wherein the substrate is part of a set of substrates; and
wherein the information characterizing the substrate is common to each substrate of the set of substrates.

14. The method according to claim 12, wherein the substrate is part of a set of substrates; and
wherein the information characterizing the substrate distinguishes the substrate from others in the set of substrates.

15. The method according to claim 12, wherein the substrate is part of a set of substrates; and
wherein the information indicates at least one of: the substrate identity, height information of a calibration substrate, a quantity of substrates in a set of substrates to which the substrate belongs, the date of an earlier process operation undergone by the substrate, the time of an earlier process operation undergone by the substrate, an apparatus used in an earlier operation of the lithographic process, and a patterning structure used in an earlier operation of the lithographic process.

16. A device manufacturing method comprising:
manufacturing a plurality of devices on a set of substrates, each substrate having a marker that indicates a position of the substrate and a feature at a position relative to the marker; and
for one of the set of substrates, determining a relative position of the marker and feature,
wherein said manufacturing includes selecting an aspect of a process operation on the substrate based on the determined relative position.

17. A lithographic substrate comprising:
a first feature; and
a second feature at a relative position to the first feature,
wherein the relative position indicates information that has been encoded onto the substrate.

18. The lithographic substrate according to claim 17, wherein the information indicates at least one of: a substrate identity, height information of a calibration substrate, a quantity of substrates in a set of substrates to which the substrate belongs, the date of an earlier process operation undergone by the substrate, the time of an earlier process operation undergone by the substrate, an apparatus used in an earlier operation of the lithographic process, and a patterning structure used in an earlier operation of the lithographic process.

19. The lithographic substrate according to claim 17, wherein the first feature is created on the substrate at a first time, and
wherein the second feature is created on the substrate at a second time separate from the first time.

20. The lithographic substrate according to claim 17, wherein the first feature is imaged onto the substrate by an exposure at a first time, and
wherein the second feature is imaged onto the substrate by an exposure at a second time separated from the first time by a period of non-exposure.
